(19) United States
(12) Patent Application Publication
(10) Pub. No.: US 2005/0047369 A1
(43) Pub. Date: Mar. 3, 2005

(54) Method and apparatus for mobility impact mitigation in a packet data communication system

(76) Inventors: Mark E. Pecen, Palatine, IL (US); Stephen A. Howell, Gloucester (GB); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/647,727

(22) Filed: Aug. 25, 2003

(51) Int. Cl. H04L 12/28; H04Q 7/00

(52) U.S. Cl. 370/331; 370/254

(57) ABSTRACT

A method and apparatus for mitigating the impact of lost data due to cell reselection for mobile stations operating in packet data transfer mode is described. A mobile station may perform cell reselection 2 to 4 times per minute when located in an urban area, even if the mobile station remains stationary. A mobile station moving through a communications network (100) may cross over various cell and routing area boundaries. Further, a mobile station operating in push-to-talk mode may lose up to 8 seconds of data when reselecting a cell in a new routing area.

A serving cell transmits an information element (301, 303, 305) in which the mobile station is informed whether cells in its neighbor list are in the same routing area as its serving cell. If the radio link to the serving cell is acceptable then the mobile station avoids reselection to cells outside its serving cell routing area.

### FIELD OF THE INVENTION

The present invention relates generally to the field of wireless communication systems and, more particularly, to a method and apparatus for mobility impact mitigation in a packet data communication system.

### BACKGROUND OF THE INVENTION

The Global System for Mobile Communication (GSM) General Packet Radio Service (GPRS) and Enhanced Data for Global Evolution (EDGE) specify transmission and receipt of data in an end-to-end packet transfer mode. GPRS and EDGE permit efficient use of radio and network resources when data transmission characteristics are; i) packet based, ii) intermittent and non-periodic, iii) possibly frequent with small transfers of data, e.g. less than 500 octets, or iv) possibly infrequent with large transfers of data, e.g. more than several hundred kilobytes. User applications may include Internet browsers, electronic mail and so on.

At the time of GPRS conception, the industry did not anticipate streaming and push-to-talk (PTT) applications that would make use of GPRS and EDGE as an underlying wireless transport mechanism. Therefore, there is no existing specified real-time handover procedure for best effort packet data transfers over GRPS/EDGE. Cell change is currently achieved by simply allowing a mobile to reselect cells as it would in idle mode. This approach to cell reselection causes a mobile station, in packet transfer mode, to abort its packet transfer on one cell and completely re-establish the ongoing transfer on the new cell.

A mobile station normally, whether it moves through the network or remains stationary, performs the cell reselection process. Each Base Transceiver Station (BTS) in the cellular communication system broadcasts a Broadcast Channel Allocation (BA) list on a Broadcast Control Channel (BCCH) or on a Packet Broadcast Control Channel (PBCCH) where a PBCCH is utilized. A mobile station in packet transfer mode, monitors the BCCH or PBCCH signal strength of the cells indicated by the BA list, also known as the neighbor list, and sequentially takes at least one radio signal strength indication (RSSI) measurement sample of a neighbor BCCH or PBCCH in every Time Division Multiple Access (TDMA) frame. The mobile station calculates, for each BCCH or PBCCH, a running average of the RSSI samples over a 5 second period and makes a cell reselection decision based upon these calculated averages.

In an urban area, cell reselection may occur 2 to 4 times per minute, even when the mobile station remains stationary. This is primarily because a mobile station uses the same autonomous cell reselection rules for GPRS/EDGE packet transfer mode as it does in idle mode as briefly described above. Therefore, a mobile station in packet transfer mode might perform cell reselection simply because an adjacent cell has a stronger radio signal than the serving cell for some pre-defined period of time, rather than because of lost coverage from the serving cell.

This cell reselection approach for packet transfer mode creates a problem for data transfer continuity, and is a particular problem for applications such as PTT. For example, assuming that a reselected cell is in the same routing area (RA) as a serving cell, the flow of data in both directions (mobile station to BTS and BTS to mobile station) may be interrupted by cell resection for time periods of approximately 500 ms to 4 seconds. Further, if the reselected cell is in an RA different than the serving cell RA, the time impact may be as much as 8 seconds.

Therefore, what is needed is a method and apparatus for mitigating the impact of data loss which occurs because of cell reselection during packet data communication.

### BRIEF DESCRIPTION OF THE DRAWINGS

FIG. 1 is a diagram representing a wireless communication system having a plurality of cells and in which cells may be grouped into routing areas.

FIG. 2 is a bit map format diagram of a Neighbor Cell Description information element.

FIG. 3 is a bit map format diagram of data octets transmitted to a mobile station from a network base station, in accordance with an embodiment of the present invention.

FIG. 4 is a flow diagram representing autonomous cell reselection avoidance in accordance with an embodiment of the present invention.

FIG. 5 is a flow diagram representing a packet data mode specific cell reselection based on a network parameter in accordance with an embodiment of the present invention.

### DETAILED DESCRIPTION OF THE PREFERRED EMBODIMENT

A first aspect of the present invention is a method of cell reselection by a mobile station communicating with a serving cell. The mobile station receives from the serving cell an information element having an indicator corresponding to the routing area of each one of a set of neighbor cells. Next, the mobile station determines whether a neighbor cell routing area is identical to the serving cell routing area. The mobile station then maintains a connection to the serving cell if the neighbor cell routing area is not identical to the serving cell routing area.

In a second aspect of the present invention, the mobile station likewise receives from the serving cell an information element having an indicator corresponding to the routing area of each one of a set of neighbor cells. Next, the mobile station estimates whether a neighbor cell routing area would provide an acceptable time delay for reselection so as to minimize data loss. The mobile station then maintains a connection to the serving cell if the neighbor cell routing area has an estimated time delay greater than a preset threshold with respect to the serving cell routing area.

In a third aspect of the present invention, the mobile station receives from the serving cell radio link budget criteria for packet transfer mode operation. Next, the mobile station determines whether the radio link budget criteria are acceptable for the serving cell. The mobile station then maintains a connection to the serving cell if the criteria are acceptable.

A fourth aspect of the present invention is a communication system comprising one or more base transceiver stations and one or more mobile stations. The base transceiver station or base transceiver stations are configurable to transmit an information element for indication of whether neighbor list base transceiver stations are associated with a routing area. The mobile station or mobile stations are configurable to receive the information element and to avoid cell reselection based upon the information element.

For a fifth aspect of the present invention, the base transceiver station or base transceiver stations are configurable to transmit a mode specific radio link budget parameter. The mobile station or mobile stations are configurable to receive the mode specific radio link budget parameter and to determine whether to perform cell reselection based upon the mode specific radio link budget parameter.

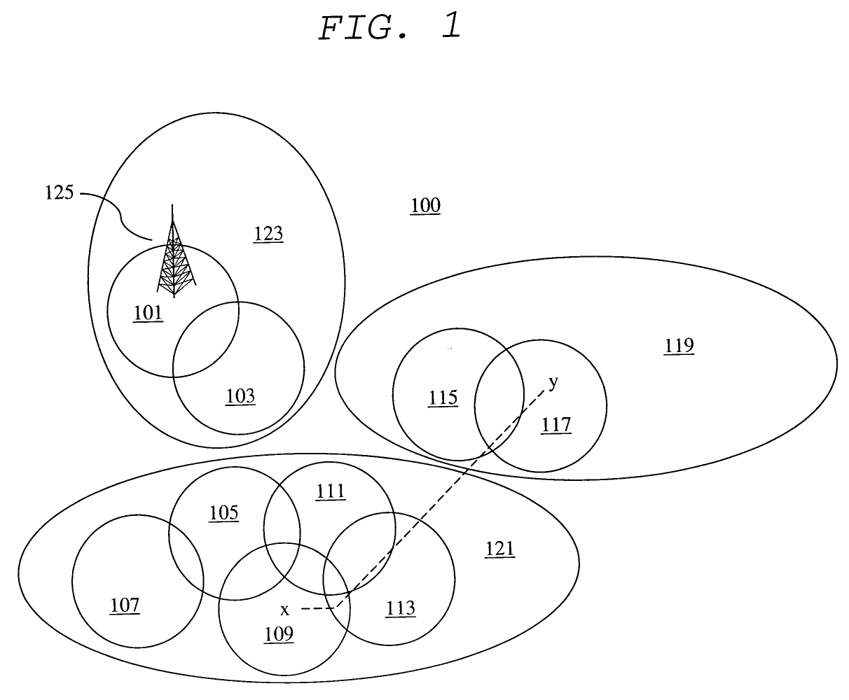

FIG. 1 is a diagram of a typical cellular communication system for use in explaining the embodiments of the present invention. It is to be understood that the present invention is not limited to the embodiments and may be utilized for other communication systems, such as Wideband Code Division Multiple Access (WCDMA) systems and other advanced generation communication systems. As illustrated in FIG. 1, a cellular communication system 100 is comprised of a number of cells 101-117, each cell having a base transceiver station (BTS) 125 which establishes a radio coverage area.

Additionally, cellular communication systems have a generally hierarchical structure in which a number of cells may be grouped into a control area, and/or further grouped into a routing area (RA). FIG. 1 illustrates hypothetical RAs 119, 121, and 123 each of which contains a number of cells.

It is to be understood that the geometries of radio coverage areas and RAs are typically not perfect geometries and that FIG. 1 makes use of such perfect geometries for simplicity of illustration only. In general, an RA will have boundaries that correspond to the radio coverage areas of the cells it contains, however an RA may also be distributed over non-continuous radio coverage areas. In any case, FIG. 1 illustrates that a mobile station moving from a position x to a position y may cross over the boundaries of several cells and may also cross the boundaries of several RAs. For example, in FIG. 1 a mobile station moving from position x to position y will cross from RA 121 to RA 119.

As the mobile station moves from position x to position y, it will perform cell reselection. As illustrated in FIG. 1, the cells reselected by the mobile station may, or may not, be within the same RA as the mobile station's serving cell.

In a first embodiment of the present invention the effect of cell reselection on packet data communications, and particularly PTT service, is mitigated by reselection avoidance logic. The mobile station may make an autonomous decision to reselect, or not, based upon knowledge of the target cell RA, and whether the target cell RA is the same as the mobile station's serving cell RA.

Returning to FIG. 1, a mobile station in packet data transfer mode, under the existing cell reselection approach, monitors the BCCH or PBCCH as previously described. The mobile station obtains a list of which BCCH carriers it should monitor by receiving a Neighbor Cell Description information element. The Neighbor Cell Description information element provides the mobile station with the absolute radio frequency channel numbers of the particular BCCH carriers the mobile station should monitor.

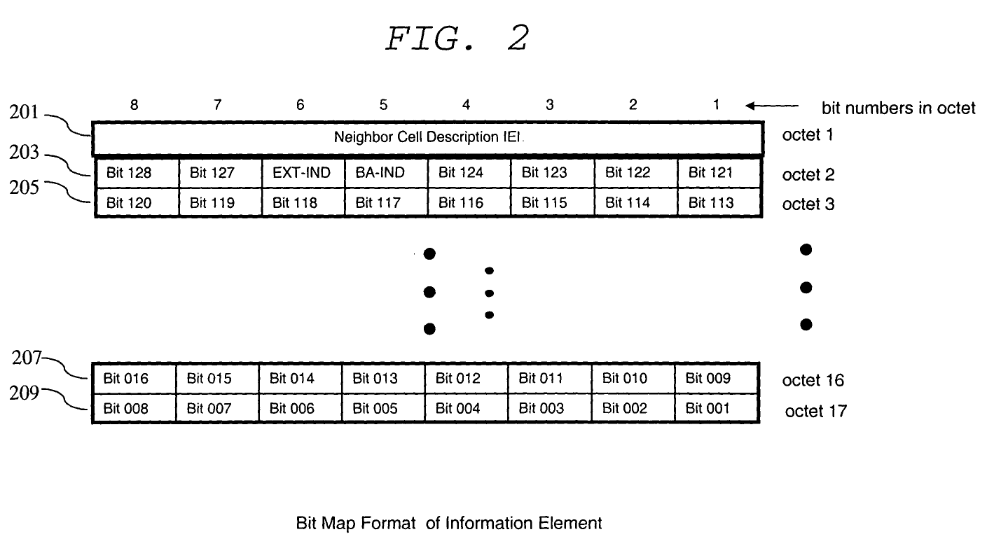

The Neighbor Cell Description information element is defined as a type 3 information element with a length of 17 octets. FIG. 2 is an illustration of the Neighbor Cell Description Element. The Neighbor Cell Description element contains a Cell Channel Description element, with the exception of bits 5 and 6 of the second octet 203. Bits 5 and 6 of octet 2 203 correspond to a “BCCH allocation sequence number indication” (BA-IND), and an “Extension Indication” (EXT-IND), respectively.

The Neighbor Cell Description list does not have a means to provide an indication of neighbor cell RA to a mobile station. In embodiments of the present invention, a single bit is used to indicate whether a neighbor cell is in the same RA as the cell transmitting the Neighbor Cell Description information element. In accordance with the present invention, this information is defined and transmitted as an “RAC membership element” information element which comprises an “RAC membership parameters” data structure.

A bit value of 1 corresponding to a logical “TRUE” indicates that a neighbor cell is within the same RA as the serving cell of the mobile station. Likewise, a logical false, which is indicated by a bit value of 0, indicates that a neighbor cell is not within the serving cell RA. Therefore, in FIG. 1, a mobile station in position x for example, may be receiving System Information (SI) messages from a BCCH carrier of cell 109. Assuming that the BCCH carrier numbers of cells 105, 107, 111, and 113 are transmitted to the mobile station via the Neighbor Cell Description information element from cell 109, then the mobile station will also receive the RAC membership element from cell 109 in accordance with the present invention. Because neighbor cells 105, 107, 111, and 113 are located within RA 121 in FIG. 1, each cell will have a bit value=TRUE because RA 121 is the same RA that contains cell 109. In some embodiments of the present invention the RAC membership element may be transmitted to a mobile station as System Information Type 2 data of two octets in length. Because only 1 bit is required to indicate RA membership of a BCCH carrier of the Neighbor list, the two octets of data can provide RA information for up to 16 BCCH carriers.

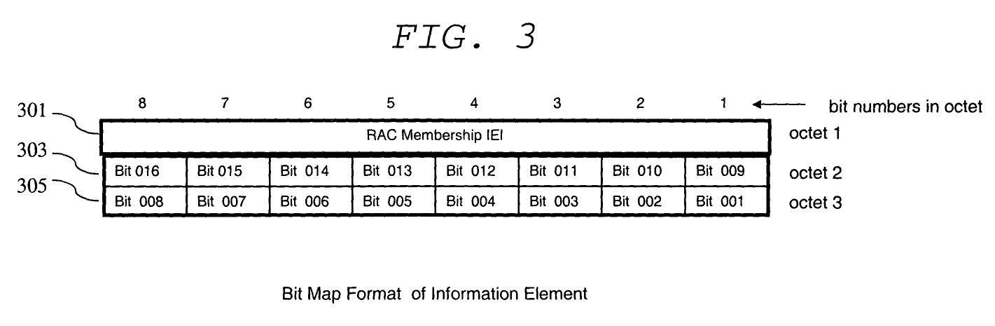

FIG. 3 illustrates the basic structure of an RAC membership information element in accordance with the present invention. In FIG. 3, octet 1 301 provides an information element identifier code. Octet 2 303 and octet 3 305 together provide 16 data bits for RA TRUE or RA FALSE indications corresponding to the type 3 Neighbor List information containing the neighbor cell BCCH carriers. In accordance with the present invention, the RAC membership information element may be transmitted from the network to the mobile station as a System Information Type 2 (SI2), dual significance message, SI2bis, S15, or SI5bis message. Additionally, in some embodiments the second octet 303 may have a number of bits utilized to specify message length for larger systems requiring transmission of more than two octets of indication data.

In accordance with the present invention a mobile station, using PTT and operating in a packet transfer mode, may set an internal timer upon assignment of a Temporary Block Flow (TBF). More particularly, a mobile station of the present invention may operate in an Extended TBF mode, in which the network will occasionally transmit a “PACKET UPLINK ACK/NACK” message to the mobile station for the purpose of maintaining the TBF mode during temporary inactive periods. The mobile station timer, which is used to determine failure of the network radio link, is initiated or reset upon receipt of the PACKET UPLINK ACK/NACK message from the network. In the case of timer reset, the mobile station remains in the TBF mode. If the timer expires, then the mobile station will perform an abnormal release and begin access retry procedures. In the embodiments of the present invention the state of this mobile station internal timer is used to determine whether the mobile station is in a packet data transfer mode.

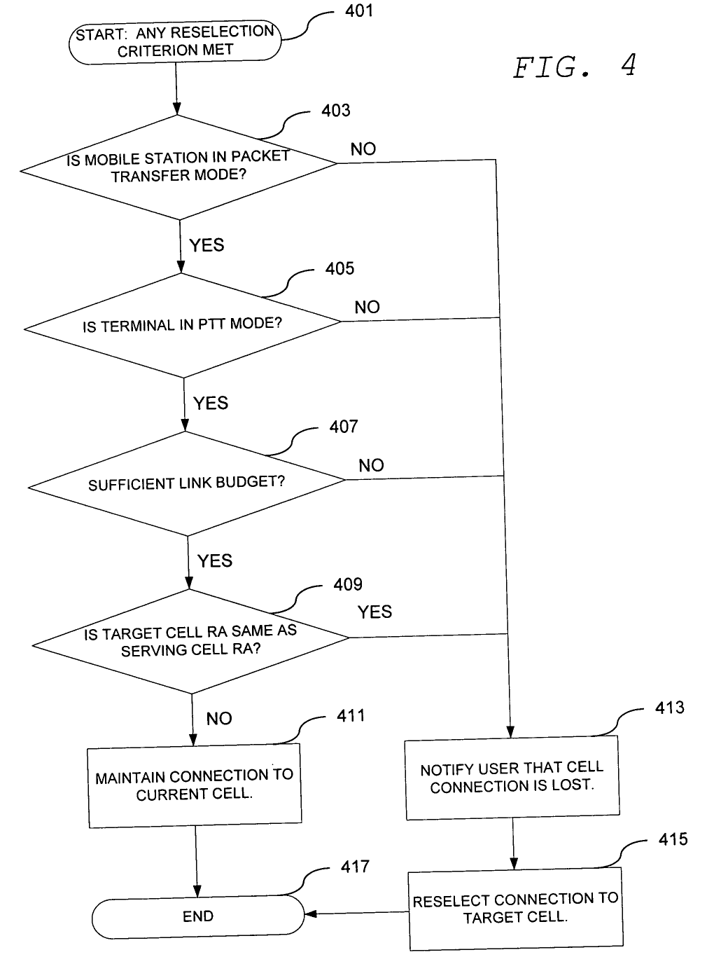

If the mobile station is in packet data transfer mode, as determined by the active state of the timer, for example timer T3184 as described in the GSM/EDGE/GPRS specifications, and the mobile station has received the RAC membership information element in accordance with the present invention, then the mobile station may apply an autonomous cell reselection avoidance scheme as illustrated by FIG. 4.

In FIG. 4, a mobile station in block 401 begins the determination of whether to perform cell reselection based on any criteria, for example the mobile station may begin to perform cell reselection when a neighbor cell BCCH RSSI is greater than that of the mobile station's serving cell. In accordance with the present invention, the mobile station in block 403 determines whether it is in a packet data transfer mode. The determination of block 403 may be made for example, by monitoring the state of internal timer T3184 which is a timer specified in the GSM/EDGE/GPRS technical specifications. If the timer is in the active state then the mobile station can be considered to be in Extended TBF mode and therefore in a packet data transfer mode.

If the timer is expired, or otherwise not active, then the mobile station may notify the user that the cell connection has been lost, by for example a notification tone or other suitable indication, as in block 413. The mobile station may then proceed with cell reselection in block 415.

Returning to block 403, if the timer is active then the mobile station determines whether it is operating in a PTT mode in block 405. If not, then the mobile station provides a lost connection indication as in block 413 and proceeds with cell reselection in block 415. If the mobile station is operating in PTT mode, then the mobile station determines whether sufficient link budget exists, i.e., a radio link budget criterion for the serving cell radio link is met.

There are several aspects involved in the mobile station link budget criteria determination. As previously discussed herein, the process generally involves measuring the RSSI of each neighbor cell BCCH over a period of time, and calculating a running average defined as “RLA_P” in the GSM/EDGE/GPRS technical specifications.

The RLA_P value is further used in calculations to determine a radio signal path loss criterion defined as “C1.” In accordance with the GSM/EDGE/GPRS technical specifications, the C1 criterion parameter is calculated for each neighbor cell and the serving cell. If the C1 parameter of the serving cell falls below zero, the mobile station reselects an appropriate neighbor cell based upon the neighbor cell C1 value and other criteria.

In addition to C1, for GPRS, the mobile station also uses a parameter defined as “C32” which is a cell ranking parameter. The C32 value is used to select a neighbor cell where two or more neighbor cells have equal priority based on other criteria parameters such as C1. A mobile station will make a cell reselection based on two conditions; 1) where the C1 parameter for the serving cell falls below zero, or 2) where a neighbor cell is evaluated as better than the serving cell and has the highest C32 value.

Because the first condition is based upon the serving cell signal strength and is indicative of a failed radio path a cell reselection should be allowed to occur. However, the second condition, based upon the C32 parameter is not so critical and therefore is modified by and in accordance with the embodiments of the present invention disclosed herein.

Therefore, returning to FIG. 4, in block 407 the mobile station determines whether the link budget criteria are met. For example, if the serving cell C1 value drops below zero, the serving cell link is unacceptable and the mobile station will proceed to block 413 and block 415 and, thus, reselect a new cell. However, if the mobile station measures a better neighbor cell criterion, as it would in the C32 parameter condition, then the neighbor cell link is superior and the mobile station will check whether the C32 target cell is within the same RA as the serving cell as illustrated by block 409. As previously described, the mobile station obtains the neighbor cell RA status via an RAC Membership information element which corresponds to the BCCH carriers indicated in the neighbor list of the Neighbor Cell Description information element.

If the target cell is not within the same RA as the serving cell, as indicated by an RAC parameter value of FALSE for the target cell, then the mobile station maintains its connection to the serving cell in block 411. If the target cell RA is identical to the serving cell RA, then the mobile station proceeds with cell reselection in block 413 and block 415.

The procedure for determining whether to perform cell reselection ends in block 417. The mobile station may begin the procedure again, based on any criteria, in block 401 or perform another function or functions.

The benefits of the herein described embodiments reduce or prevent the loss of voice data during PTT communication and thus provide an improved PTT communication system over known implementations.

In a second embodiment of the present invention, a network operator may control the reselection processes, for mobile stations in packet data transfer mode, by a predefined network path loss parameter. In accordance with the second embodiment a new parameter is defined as “C1_P” which is applied by the mobile station when operating in a packet data transfer mode, or when using an application that would be severely degraded by frequent cell reselection, such as PTT.

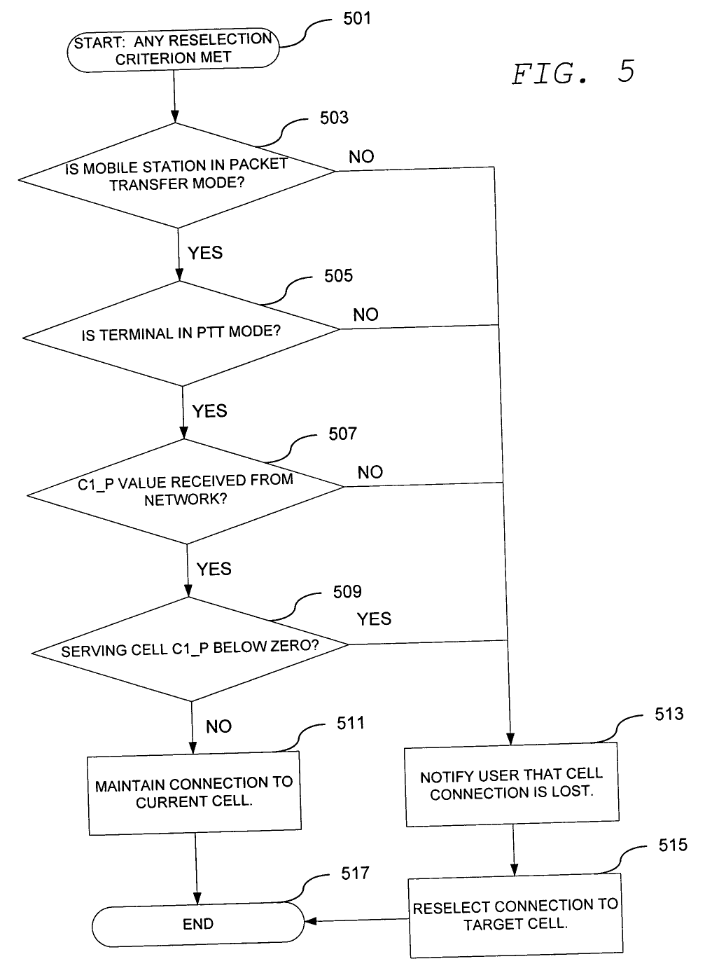

A mobile station operating in packet data transfer mode, which receives the C1_P parameter from the network will ignore the C1 and C32 parameters and will only take reselection action based upon C1_P. FIG. 5 illustrates a procedure of the second embodiment of the present invention. In FIG. 5, block 501, a mobile station begins the determination of whether to perform cell reselection based upon any criteria, for example the mobile station may begin to perform cell reselection when a neighbor cell BCCH RSSI is greater than that of the mobile station's serving cell. This operation is the same operation as that of FIG. 4 block 401.

In block 503, similar to block 403, the mobile station determines whether it is in a packet data transfer mode. The determination of block 503 is identical to that of block 403. For example, the mobile station may monitor the state of internal timer T3184. If the timer is in the active state then the mobile station can be considered to be in Extended TBF mode and therefore in a packet data transfer mode.

If the timer is expired, or otherwise not active, then the mobile station may notify the user that the cell connection has been lost, by for example a notification tone or other suitable indication, as in block 513. The mobile station may then proceed with the cell reselection in block 515.

Returning to block 503, if the timer is active then the mobile station determines whether it is operating in a PTT mode in block 505. If not, then the mobile station provides a lost connection indication as in block 513 and proceeds with cell reselection in block 515. If the mobile station is operating in PTT mode, then the mobile station determines whether the radio link budget criteria for the serving cell radio link is met.

In block 507, the mobile station must have received the C1_P parameter such that it may make the link budget determination based upon C1_P in block 509. If the parameter is not received by the mobile station in block 507, or if the serving cell link is found unacceptable in block 509, then the mobile station will proceed to cell reselection blocks 513 and 515. However, if C1_P has been received in block 507, and the serving cell radio link remains acceptable in block 509, then the mobile station maintains its connection to its current serving cell in block 511.

The procedure for determining whether to perform cell reselection ends in block 517. The mobile station may begin the procedure again, based on any criteria, in block 501 or perform another function or functions.

It is to be understood that the determination of acceptable radio link in block 509 is based upon the parameter C1_P in accordance with the present invention and that parameters C1 and C32, which the mobile station uses in idle mode, will be ignored in block 509. Therefore the present invention enables a mode-specific cell reselection procedure for mobile stations in packet transfer mode. A mobile station operating in accordance with the present invention will therefore have an improved data communication, particularly for PTT, as opposed to a mobile station that merely uses the cell reselection procedures of idle mode.

While the preferred embodiment of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method of cell reselection by a mobile station communicating with a serving cell comprising:
receiving from said serving cell an information element having an indicator corresponding to the routing area of each of a set of neighbor cells;
comparing a neighbor cell routing area to said serving cell routing area; and
executing a reselection decision in response to comparing said neighbor cell routing area to said serving cell routing area.

2. The method of claim 1, wherein executing a reselection decision includes maintaining connection to said serving cell if said neighbor cell routing area is different from said serving cell routing area.

3. The method of claim 1, further comprising:
determining that said mobile station is operating in a packet data transfer mode.

4. The method of claim 1, further comprising:
determining that said mobile is operating in a push-to-talk mode.

5. The method of claim 1, further comprising:
determining whether a radio link budget criteria is acceptable for said serving cell.

6. The method of claim 1, wherein said information element is transmitted to said mobile station from said serving cell as one of an SI2, SI2bis, SI5, and SI5bis message.

7. The method of claim 1, wherein said information element comprises at least two octets of true/false indicators and wherein a true indication corresponds to a neighbor cell having a routing area identical to the routing area of said serving cell.

8. A method of cell reselection by a mobile station communicating with a serving cell comprising:
receiving from said serving cell an information element having an indicator corresponding to the routing area of each of a set of neighbor cells;
estimating a reselection time delay for said neighbor cell;
comparing said reselection time delay to a threshold value; and
executing a reselection decision in response to comparing said reselection time delay to said threshold value.

9. The method of claim 8, wherein executing a reselection decision includes maintaining connection to said serving cell if said reselection time delay for said neighbor cell is above the threshold value.

10. The method of claim 8, further comprising:
determining that said mobile station is operating in a packet data transfer mode.

11. The method of claim 8, further comprising:
determining that said mobile is operating in a push-to-talk mode.

12. The method of claim 8, further comprising:
determining whether a radio link budget criteria is acceptable for said serving cell.

13. The method of claim 8, wherein said information element is transmitted to said mobile station from said serving cell as one of an SI2, SI2bis, SI5, and SI5bis message.

14. The method of claim 8, wherein said information element comprises at least two octets of true/false indicators and wherein a true indication corresponds to a neighbor cell having a routing area wherein a time delay may be estimated with respect to the routing area of said serving cell.

15. A method of cell reselection by a mobile station communicating with a serving cell comprising:
receiving from said serving cell, a radio link budget criteria for packet transfer mode operation;
determining whether said radio link budget criteria is acceptable for said serving cell; and
executing a reselection decision in response to determining whether said radio link budget criteria is acceptable for said serving cell.

16. The method of claim 15, wherein executing a reselection decision includes maintaining connection to said serving cell if said criteria is acceptable.

17. The method of claim 15, further comprising:
determining whether said mobile station is operating in a packet transfer mode.

18. The method of claim 15, further comprising:
determining whether said mobile station is operating in a push to talk-mode.

19. A communications system comprising:
at least one base transceiver station configurable to transmit an information element for indication of whether neighbor list base transceiver stations are associated with a routing area; and
at least one mobile station configurable to receive said information element and to avoid cell reselection based upon said information element.

20. The communication system of claim 19, wherein said information element provides indicators that neighbor list base transceiver stations are located within the same routing area as said at least one base station transceiver.

21. The communication system of claim 19, wherein said information element is transmitted as one of a SI2, SI2bis, S15 and SI5bis message.

22. The communication system of claim 19, wherein said information element comprises at least two octets of true/false indicators and wherein a true indication corresponds to a neighbor list base transceiver station having a routing area identical to said base transceiver station.

23. The communication system of claim 19, wherein said true/false indicators are single bit indicators.

24. A communication system comprising:
at least one base transceiver station configurable to transmit a mode specific radio link budget parameter; and
at least one mobile station configurable to receive said mode specific radio link budget parameter and to determine whether to perform cell reselection based upon said mode specific radio link budget parameter.

25. The communication system of claim 24, wherein said mode specific radio link budget parameter is a packet data transfer mode radio link budget parameter.

26. A method of selecting reselection criteria by a mobile station communicating with a serving cell comprising:
determining whether a terminal mode of the mobile station is one of a packet data mode and a push-to-talk mode;
executing a first reselection process in response to determining that the mobile station is in the packet data mode; and
executing a second reselection process in response to determining that the mobile station is in the push-to-talk mode.

27. The method of claim 26, wherein executing a first reselection process includes determining whether a routing area of a neighbor cell is associated with a routing area of the serving cell.

28. The method of claim 27, wherein executing a first reselection process further includes maintaining connection to the serving cell if the routing area of the neighbor cell is dissimilar from the routing area of the serving cell.

29. The method of claim 26, wherein executing a first reselection process includes estimating a reselection time delay for a neighbor cell and determining whether the time delay is above a threshold value.

30. The method of claim 29, wherein executing a first reselection process further includes maintaining connection to the serving cell if the reselection time delay for the neighbor cell is above the threshold value.

31. A method of selecting reselection criteria by a mobile station communicating with a serving cell comprising:
determining whether a terminal mode of the mobile station is one of a packet data mode and a push-to-talk mode;
executing a first reselection process in response to determining that the mobile station is in the packet data mode; and
executing a second reselection process in response to determining that the mobile station is in the push-to-talk mode.

32. The method of claim 31, wherein executing a second reselection process includes determining whether a routing area of a neighbor cell is associated with a routing area of the serving cell.

33. The method of claim 32, wherein executing a second reselection process further includes maintaining connection to the serving cell if the routing area of the neighbor cell is dissimilar from the routing area of the serving cell.

34. The method of claim 31, wherein executing a second reselection process includes estimating a reselection time delay for a neighbor cell and determining whether the time delay is above a threshold value.

35. The method of claim 34, wherein executing a second reselection process further includes maintaining connection to the serving cell if the reselection time delay for the neighbor cell is above the threshold value.
